(19) United States
(12) Patent Application Publication
(10) Pub. No.: US 2009/0132977 A1
(43) Pub. Date: May 21, 2009

(54) METHOD OF ESTABLISHING COUPON BAR

(75) Inventors: Chiao-Yu YU, Taipei (TW); Yung-Chien CHENG, Taipei (TW); Chiu-Feng TSAI, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 11/943,967

(22) Filed: Nov. 21, 2007

(51) Int. Cl. G06F 17/50

(52) U.S. Cl. 716/5

(57) ABSTRACT

A method of establishing a coupon bar is applied to circuit layout of a multi-layer printed circuit board (PCB). A coupon bar library storing a great number of coupon bars and sets of setting parameters each corresponding to a coupon bar is connected. A set of parameters including a layer number value, a board thickness value, a line width value, and a distance value is input. The set of inputted layout parameters is compared with the setting parameters stored in the coupon bar library, so as to obtain a set of setting parameters and the corresponding coupon bar matching with each other. The obtained coupon bar is laid on one layer of the multi-layer PCB.

### BACKGROUND

1. Field of Invention

The present invention relates to a method for laying out a circuit on a multi-layer PCB, and more particularly to a method of establishing a coupon bar and a coupon bar library to lay out effective circuit.

2. Related Art

With the rapid development of electronic technology and semiconductor devices in recent years, circuit design and functions thereof have been improved significantly. Currently, the industry is making progress in higher layout density and multifunctional layout design in terms of circuit design. Supported by layout software, high-speed and simulatable layout technology has been developed.

However, in the conventional layout technology, persons skilled in the art perform layout and measure whether the circuits are connected correctly on the basis of their personal skills, so a lot of labor and time must be spent on the layout and error detection. Moreover, as the layout density is becoming increasingly higher in circuit design now, manual layout often leads to human errors and difficulties in error detection. The human errors reduce the yield of circuit production, and the manufacturing cost is increased because the board cleaning and layout must be repeated.

In addition, as the circuit layout relies much on the personal experience of those skilled in the art in the conventional art, the industry must spend time on training and correcting the persons who are not experienced; or when the experienced persons cannot continue the work, the process technology often becomes insufficient. Moreover, persons skilled in the art often use impedance test circuits that they produced in the past due to different individual using and designing habits. As different persons have different habits, the circuits cannot be shared by others, resulting in a cost of both labor and technical resources.

### SUMMARY

Accordingly, the present invention is directed to establishing standard coupon bars, and collecting the coupon bars into a coupon bar library, so as to solve the problems of the conventional art that much labor and time is required and the process cost is increased due to using manual circuit layout and error detection only.

In order to achieve the aforementioned objective, the present invention provides a method of establishing a coupon bar applied to circuit layout of a multi-layer PCB. The method includes the following steps. Firstly, a coupon bar library is connected, the coupon bar library stores a great number of coupon bars and a great number of setting parameters, and each coupon bar is corresponding to a set of setting parameters. Then, a set of layout parameters is input, and the set of layout parameters includes a layer number value representing the number of layers of the multi-layer PCB, a board thickness value representing a thickness of each circuit board layer of the multi-layer PCB, a line width value representing a width of impedance lines laid on the multi-layer PCB, and a distance value representing a distance between the impedance lines laid on the multi-layer PCB. The entire set of layout parameters is compared with the set of setting parameters, so as to obtain the matching setting parameters and the coupon bar corresponding to the matching setting parameters. Finally, the obtained coupon bar is laid on a layer of the multi-layer PCB.

The present invention is characterized in the provided coupon bar library. The coupon bar library includes a plurality of coupon bars of standard formats and a plurality of impedance lines copied from a circuit area. Therefore, the coupon bars enable persons skilled in the art to measure the impedance lines in the coupon bars directly, and reduce the human errors caused by complicated circuits in the circuit area. Meanwhile, the collection of the library allows direct selection of complicated circuit layout from the library, so as to save time and provide good technical continuity. Therefore, the present invention effectively reduces the waste on labor and time and human errors in circuit layout, and lowers the process cost.

The description on the content of the present invention above and the description on the embodiments below are used to exemplify and explain the principle of the present invention, and provide further explanation on the claims of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1A is a schematic exploded view of a multi-layer PCB;

FIG. 1B is a schematic view of a circuit board having coupon bars;

FIG. 2 is a flow chart of a method of establishing a coupon bar of the present invention;

FIG. 3A is a schematic view of a coupon bar of the present invention;

FIG. 3B is a flow chart of a detailed method of establishing a coupon bar; and

FIG. 4 is a flow chart of the method using the coupon bar library of the present invention.

### DETAILED DESCRIPTION

To make the object, structure, features and function of the present invention more understandable, the present invention is illustrated below in detail with reference to the embodiments.

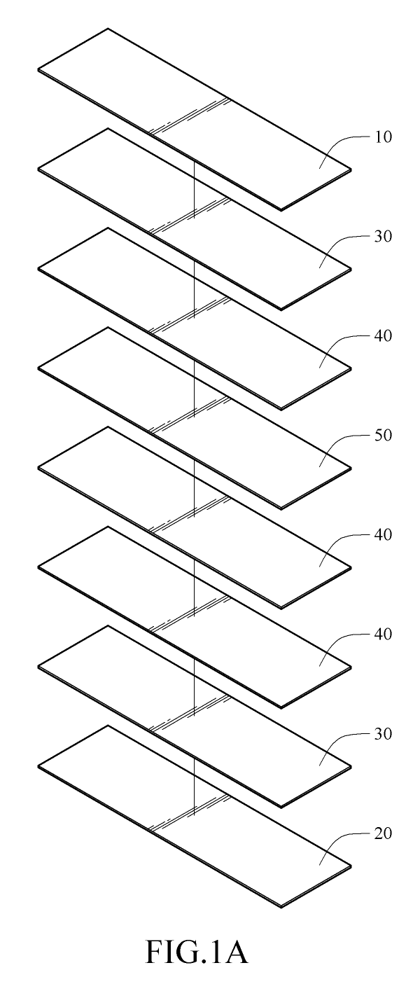

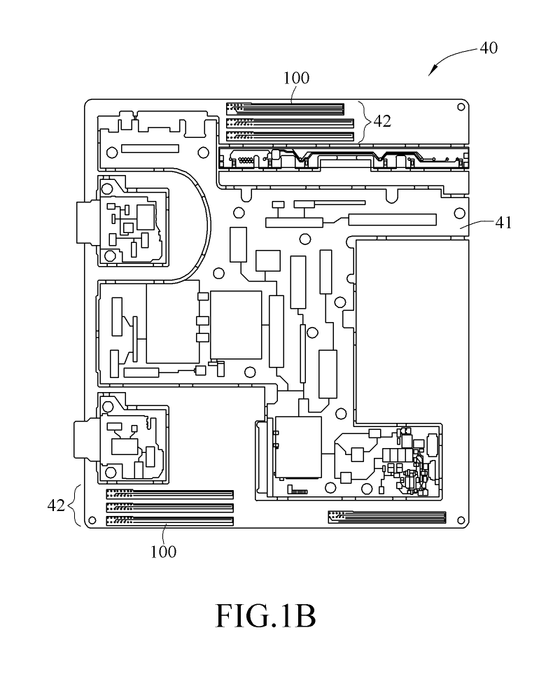

FIG. 1A is a schematic exploded view of a multi-layer PCB. FIG. 1B is a schematic view of a circuit board having impedance test lines. Referring to FIGS. 1A and 1B, in this embodiment, an 8-layer PCB including a top layer 10, a bottom layer 20, a plurality of grounding layers 30, a plurality of signal layers 40 and a power layer 50 is taken as an example. Each layer has circuit layout connected finely. As shown in FIG. 1B, taking a signal layer 40 for example, in the present invention, the signal layer 40 has a circuit area 41 and a test area 42. The circuit area 41 has circuit layout connected to various layers finely, and is the main work area of the circuit board of the signal layer 40. The test layer 42 has a plurality of coupon bars 100, and is commonly grounded with, but not directly electrically connected to, the circuit area 41. When a circuit is disposed in the circuit area 41, the circuit can be copied to the test area 42 at the same time. Therefore, the impedance of the same circuit in the test area 42 copied from the circuit area 41 can be measured directly instead of measuring the complicated circuit area 41, so as to improve the precision of the measurement.

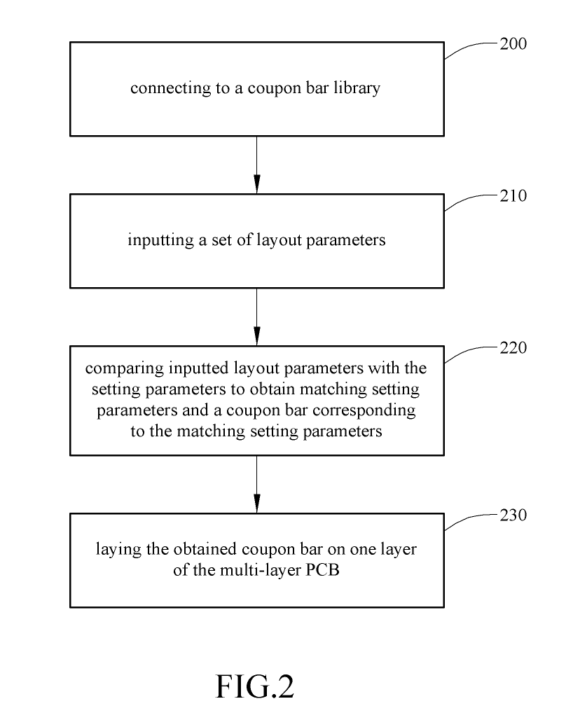

FIG. 2 is a flow chart of a method of establishing a coupon bar of the present invention. The method of establishing a coupon bar of the present invention is as follows. Firstly, a multi-layer PCB on which the coupon bars 100 are to be applied is connected to a preset coupon bar library, and the coupon bar library stores a great number of coupon bars 100 and sets of setting parameters each corresponding to a coupon bar 100 (step 200). Then, a set of layout parameters is input by a user (step 210). Each set of parameters includes a layer number value representing the number of layers of the multi-layer PCB, a board thickness value representing a thickness of each circuit board layer of the multi-layer PCB, a line width value representing a width of impedance lines laid on the multi-layer PCB, and a distance value representing a distance between the impedance lines laid on the multi-layer PCB. Then, the set of layout parameters inputted is compared with the setting parameters stored in the coupon bar library (step 220). If matching, the coupon bar 100 corresponding to the matching set of setting parameters is obtained. Finally, the obtained coupon bar 100 is laid on one layer of the multi-layer PCB (step 230).

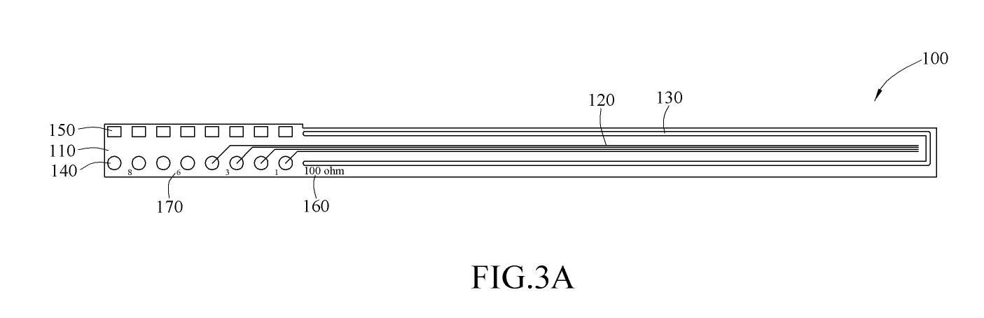

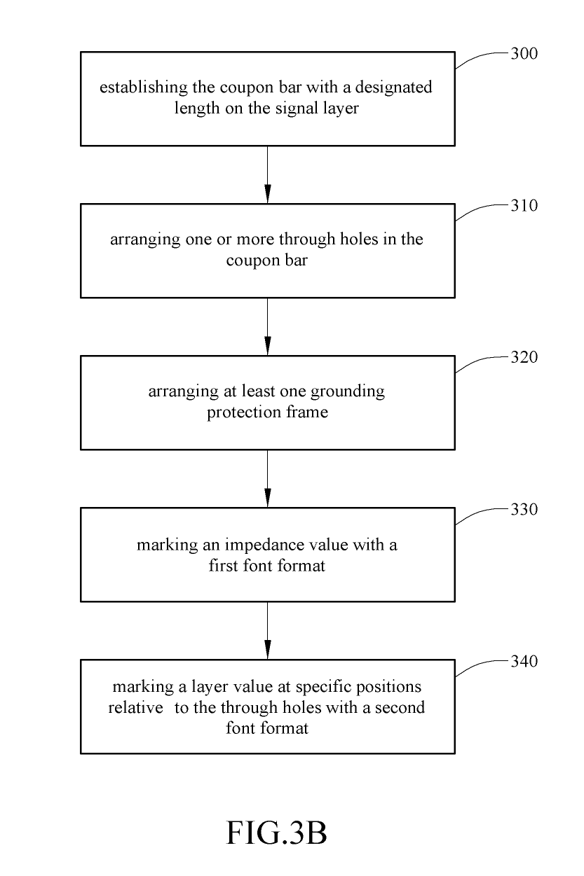

Referring to FIG. 1A, FIG. 3A and FIG. 3B, FIG. 3A is a schematic view of a coupon bar of the present invention, and FIG. 3B is a flow chart of a detailed method of laying the coupon bar. As shown in FIG. 3A, the present invention is applied in the circuit design of multi-layer PCBs using layout software. The coupon bar 100 of the present invention includes a side frame 110, impedance lines 120, a grounding protection frame 130, round through holes 140, square through holes 150, a first font format 160, and a second font format 170.

The method of laying the coupon bar is as follows. Firstly, a coupon bar 100 with a designated length is established on the signal layer 40 (step 300). One or more through holes are arranged in both ends of the coupon bar 100, such that the impedance lines 120 are electrically connected to the signal layer 40 and/or the grounding layer 30 respectively via the through holes (step 310). At least one grounding protection frame 130 is arranged, and the grounding protection frame has a designated width and is spaced from the impedance lines 120 at a specific distance (step 320). An impedance value is marked beside/in the coupon bar 100, the impedance value represents the impedance of the impedance lines 120, and the marked impedance value has a first font format 160 (step 330). A layer value is marked at specific positions relative to the through holes 140, e.g. beside the through holes 140, and the layer value has a second font format 170 (step 340).

Referring to FIG. 3A, the designated length of the side frame 110 is set to be 3 inches, and the grounding protection frame 130 of a designated width is arranged on the inner periphery of the side frame 110. The grounding protection frame 130 surrounds the impedance lines 120, and is at a distance of 20 mils to the impedance lines 120. Moreover, the designated width of the grounding protection frame 130 is also 20 mils. The grounding protection frame 130 is used to ensure that the circuit will not be electrically connected to the circuit area 41 by accident. In addition, in FIG. 3A, the square through holes 150 and the round through holes 140 are arranged in upper and lower ends of the coupon bar 100 respectively, so as to electrically connect the circuit to other layers of the multi-layer PCB. The square through holes 150 are used for connection to the grounding layer 30, and a square pad is disposed at the square through hole 150 and the grounding layer 30. The round through holes 140 are used for connection to another signal layer 40, and a round pad is disposed at the round through hole 140 and the signal layer 40.

After that, in the step of marking the impedance value on the coupon bar 100, the marked impedance value has the first font format 160, including a height, an aspect ratio, and a stroke width. In this embodiment, the height is set to 0.045 inches, the aspect ratio is 0.7 (i.e., the character width is 0.7 units when the character length is 1 unit), and the stroke width is 0.006 inches. Though the height, aspect ratio, and stroke width are set to the above values in this embodiment, the settings are not used to limit the method to implement the present invention. The settings can be adjusted according to requirements of users.

Moreover, layer values showing the layers that the square and round through holes 150 and 140 are connected to are marked below the square and round through holes 150 and 140 respectively. The marked layer values have a second font format 170. Similarly, the second font format 170 also includes another height, another aspect ratio, and another stroke width. However, the second font format 170 is different from the first font format 160. In this embodiment, the height of the second font format 170 is set to 0.04 inches, the aspect ratio is 0.5 (i.e., the character width is 0.5 units when the character length is 1 unit), and the stroke width is 0.006 inches.

However, the method of establishing a coupon bar of the present invention is not only used to improve the precision in measurement, but also has the following effects.

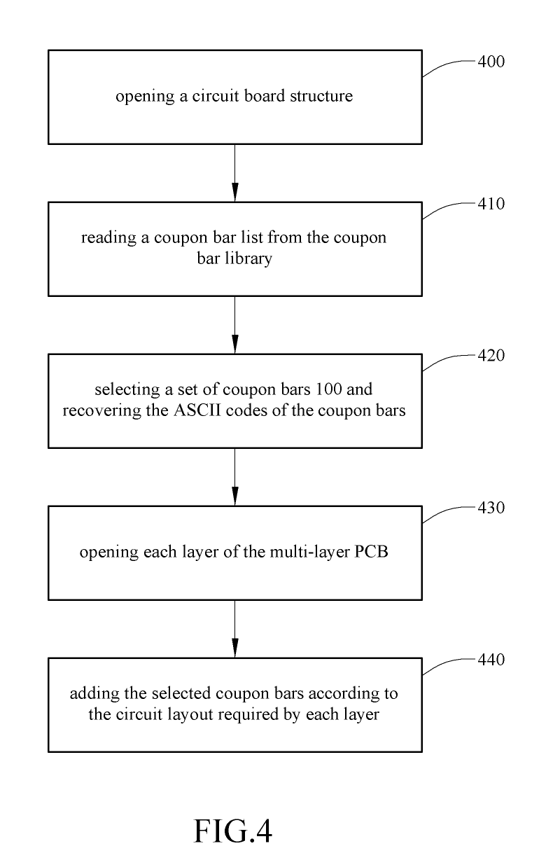

FIG. 4 is a flow chart of the method using the coupon bar library of the present invention. When the coupon bars 100 are established and marked according to the above method, the coupon bar library can be formed. Then, the user can directly select a set of coupon bars 100 in the coupon bar library directly and distribute it on the circuit board according to actual requirements and the design with computer software. The steps are as shown in FIG. 4. Firstly, a circuit board structure is opened (step 400). A coupon bar list is read from the coupon bar library (step 410). Then, a set of coupon bars 100 is selected, and the ASCII codes of the coupon bars 100 are recovered (step 420). Next, each layer of the multi-layer PCB is opened (step 430), and the selected coupon bars 100 are added according to the circuit layout required by each layer (step 440). Therefore, the problems caused by human errors of persons skilled in the art in layout can be reduced significantly.

The coupon bar library of the present invention includes a plurality of coupon bars and a plurality of impedance lines copied from a circuit area. Therefore, the coupon bars enable persons skilled in the art to measure the impedance lines in the coupon bars directly, and reduce the human errors caused by complicated circuits in the circuit area. Meanwhile, the collection of the library allows direct selection of complicated layout from the library, so as to save time and provide good technical continuity. Therefore, the present invention effectively reduces the waste on labor and time and human errors in circuit layout, and lowers the process cost.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of establishing a coupon bar applied to a circuit layout of a multi-layer printed circuit board (PCB), comprising:
connecting to a coupon bar library storing a great number of setting parameters and a great number of coupon bars each corresponding to a set of the setting parameters;
inputting a set of layout parameters, including a layer number value representing the number of layers of the multi-layer PCB, a board thickness value representing a thickness of each the layer of the multi-layer PCB, a line width value representing a width of an impedance line laid on the multi-layer PCB, and a distance value representing a distance between the impedance lines laid on the multi-layer PCB;
comparing the set of layout parameters with the setting parameters stored in the coupon bar library, so as to obtain the matching set of the setting parameters and the coupon bar corresponding to the matching set of the setting parameters; and
laying the obtained coupon bar on one of the layers of the multi-layer PCB.

2. The method of establishing a coupon bar as claimed in claim 1, wherein the multi-layer PCB comprises at least one grounding layer and at least one signal layer.

3. The method of establishing a coupon bar as claimed in claim 2, wherein the step of laying the obtained coupon bar comprises:
establishing the coupon bar with a designated length on the signal layer;
arranging at least one through hole in the coupon bar, wherein the through hole is used for connecting the impedance line and one of the other signal layer and the grounding layer;
arranging at least one grounding protection frame having a designated width and at a specific distance to the impedance line;
marking an impedance value in the coupon bar, wherein the impedance value represents the impedance of the coupon bar, and the marked impedance value has a first font format; and
marking a layer value at a specific position relative to the through hole, wherein the marked layer value has a second font format.

4. The method of establishing a coupon bar as claimed in claim 3, wherein the designated length of the coupon bar is 3 inches.

5. The method of establishing a coupon bar as claimed in claim 3, wherein the step of arranging at least one through hole in the coupon bar further comprises arranging a square pad at the through hole connected with the grounding layer.

6. The method of establishing a coupon bar as claimed in claim 3, wherein the step of arranging a through hole in each of two ends of the coupon bar further comprises arranging a round pad at the through hole connected with the signal layer.

7. The method of establishing a coupon bar as claimed in claim 3, wherein the specific distance in the step of arranging at least one grounding protection frame is 20 mils ( 1/1000 inch).

8. The method of establishing a coupon bar as claimed in claim 3, wherein the designated width of the grounding protection frame is 20 mils.

9. The method of establishing a coupon bar as claimed in claim 3, wherein the first font format is different from the second font format.

10. The method of establishing a coupon bar as claimed in claim 3, wherein the first font format of the impedance value comprises a height, an aspect ratio, and a stroke width.

11. The method of establishing a coupon bar as claimed in claim 10, wherein the height is 0.045 inches.

12. The method of establishing a coupon bar as claimed in claim 10, wherein the aspect ratio is 0.7.

13. The method of establishing a coupon bar as claimed in claim 10, wherein the stroke width is 0.006 inches.

14. The method of establishing a coupon bar as claimed in claim 3, wherein the specific position of the layer value relative to the through hole is below the through hole.

15. The method of establishing a coupon bar as claimed in claim 3, wherein the second font format of the impedance value comprises a height, an aspect ratio, and a stroke width.

16. The method of establishing a coupon bar as claimed in claim 15, wherein the height is 0.04 inches.

17. The method of establishing a coupon bar as claimed in claim 15, wherein the aspect ratio is 0.5.

18. The method of establishing a coupon bar as claimed in claim 15, wherein the stroke width is 0.006 inches.
